(19) United States
(12) Patent Application Publication
(10) Pub. No.: US 2019/0028470 A1
(43) Pub. Date: Jan. 24, 2019

(54) Method For Verifying The Identity Of A Person

(71) Applicant: KK88.no AS, Ski (NO)

(72) Inventor: Harald Marthinussen, Ski (NO)

(21) Appl. No.: 16/069,085

(22) PCT Filed: Jan. 12, 2017
(86) PCT No.: PCT/NO2017/050011

§ 371 Date: Jul. 10, 2018

(30) Foreign Application Priority Data
Jan. 12, 2016 (NO) 20160057

(51) Int. Cl. H04L 29/06; H04W 12/06; G06K 9/00

(52) U.S. Cl. CPC H04L 63/0861; H04L 63/0876; H04L 2463/082; G06K 9/00892; H04W 12/06

(57) ABSTRACT

A method for generating a unique personal safe Cyber biometric identification of one user as needed by suppliers, without revealing the user's real biometric images, for use in a system for authenticating the user of a service. The system includes equipment and a portable device communicating wirelessly with each other. The equipment is adapted to request the portable device to perform and mix at least two different biometric readings on the user in order to provide a new biometric image, without revealing the real identity of the original biometric images. The portable device is adapted to perform said at least two biometric readings on the user, combine the biometric readings forming a new mixed Cyber identity and transmit the mixed readings to the equipment, which compares the received mixed readings with the stored Cyber biometric data, and if they agree, allow the user to access the online services.

### FIELD OF THE INVENTION

The present invention relates to a method for verifying the identity of a person.

### BACKGROUND

In today's digital society banks, governments, military, healthcare, hospitals and all companies need to protect their enormous amount of data from thieves, hackers and all unauthorized users. To connect to such a service, a user has to verify one or more personal cods as usernames, passwords, puck codes, social security numbers, birth date or biometric identification. In addition, the safety systems may have to scan your user ID cards as smart card, bankcards, company issued access cards to verify the right to connect. Apart from the strain of having to remember a lot of personal codes, the exchange of information makes the user vulnerable for personal theft, for example by onlookers gleaning the codes entered into a banking automate or used for opening a door, criminals mounting skimmers on banking automates, phishing or obtaining ID codes in other ways, or by hackers breaking into computers or smartphones, or breaking codes for using a service. It is well known that criminals have emptied bank accounts of unlucky victims and even taken over their “Cyber world” identity. There have been several attempts of solving this problem by using biometric readings for identifying a user for gaining access to an account on a computer. However, such systems require all users to be registered on beforehand, and are also only as secure as the system itself, i.e. a hacker may break the system, “get inside” and get access to the ID codes and biometric data.

Codes as username, passwords, puck codes are now substituted with biometric identification as large corporations, government as banks have decided to require your biometrical identification to secure its self against wrong users. This could have been an ideal digital world without criminals and hackers. As our digital world is full of large digital information thefts our biometric data is endangered. A person's 15 biometric unique images cannot be replaced, as codes and passwords, if stolen by hackers. If a person biometrical identity is stolen your life may be controlled by criminals or hackers. If a person loses all her/his biometric identity he/her may be digital dead forever.

International patent application WO 2014/021721, owned by the present applicant and the content of which is hereby incorporated by reference, discloses a portable system for authenticating a user trying to access a service, said device including a CPU, ROM, RAM, at least one biometric reader, and communication means, the device being operated only by data permanently stored in the ROM, the RAM being flushed after each operating cycle. The device is adapted to read the user's private information (as smart card) and the user's private biometric data (as from fingerprints, voice, eye-iris, face shape readers). This information is mixed together with the device's unique readable production series number to secure a special coded startup of all your private equipment and help you to connect safely to your bank account, your data storage on the clouds, your government files etc. The benefit of this device is that it does not contain any information about the user. Thus, if it is lost or stolen, any other person who comes in possession of the device cannot use it to fake access to your services.

### SUMMARY OF THE INVENTION

The object of the present invention is to provide a portable device as disclosed in WO 2014/021721 with a highly improved personal security level of a user. The invention is a personal identification solution to secure one (1) user, having many safety functions such as flushing the RAM after each identification cyclus, secure each person using a production series number creating each unit unique with the user.

Another invention is to generate a unique biometric identification of a user, as needed by the suppliers, without reviling her/his real biometric images. The invention is based on a solution to generate secure personal cyber biometrical identification, unique to only the user, without compromising his real biometric values, giving the user the same options to change his cyber biometric identification if stolen, same as for cods and password when lost or stolen.

This is achieved in a method, system, device and equipment as defined in the following claims.

In particular, the present invention relates to a method for authenticating a user of a system providing access to a service, the system including any service equipment and a portable device communicating wirelessly with each other, the service equipment including or having access to a storage containing biometric data relating to said user, the portable device including a multitude of biometric readers, wherein the method including the steps of:

the service equipment requesting the portable device to perform at least two different selected biometric readings on the user,

the portable device performing said biometric readings on the user, combining said biometric readings forming a new mixed biometric identity of the user and transmitting the new mixed biometric identity to the service equipment,

the service equipment comparing the received mixed biometric identity with the stored biometric data, and if said received and stored biometric data agree, allowing the user access to the service.

The combination of at least two different biometric readings provides extra high security as the invented device mixes two or more biometric readings in order to provide, produce a new biometric image, without revealing the real identity of the original biometric images. The new image, a Cyber biometric image looking like and will be identified as any other biometric identifications used in the digital market for a user.

As the invented device create a unique Cyber biometric image, of the user, using a mix of biometric readings, mechanical selection and a production solution and the new cyber biometric image look like standard biometric images from fingers, Iris, voice and face shape it will function as normal identifications used in Window 10, Android and iOS in mobile, PC, PAD, on internet, on payment terminals and banking without using the real biometric values.

In the signals sent from the portable device to the service equipment, it is very difficult for a potential intruder to deduce which parts of the signals that belongs to which biometric reading and the personal safety for the user is obtain, even if stolen by criminals and hackers.

In a preferred embodiment of the system, all said biometric readings are selected at random by the service equipment, or that one of the biometric readings is selected by the user, the other biometric readings being selected at random by the service equipment, or that all biometric readings are selected at random by the portable device. The benefit of this system is that someone trying to get unauthorized access to the system cannot foresee what information that must be provided in order to get the access.

According to the invention, a production serial number may be stored in the portable device, the portable device being adapted to combine the production serial number, or a part of the production serial number, with the biometric readings before transmitting the result to the service equipment.

The portable device may be adapted to encrypt the communication sent to the service equipment at the personal user selection.

When the portable device is used to identify a access or start up a single smart unit we recommend the personal user to select Bluetooth 4.3 communication, giving an encrypted security level quite impossible to use eavesdropping data as the same image change its encryptions, each time it is transmitted, so hackers can't match the Cyber biometric image stored in the equipment.

### BRIEF DESCRIPTION OF THE DRAWINGS

The invention is now to be described in detail in reference to the appended drawings, in which:

FIG. 1a is a schematic illustration in front view of a portable identification device according to the present invention,

FIG. 1b shows the device in side view,

FIG. 1c shows the back side of the inventive portable device,

FIG. 2 is a schematic circuit diagram of the inventive portable device, and

FIG. 3 is a schematic diagram of the inventive system with portable device and service equipment.

### DETAILED DESCRIPTION

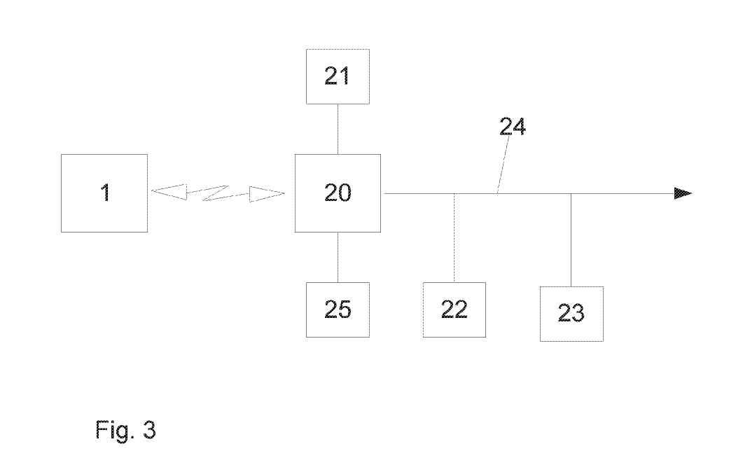

As shown in the drawings, the invention relates to a small portable device 1 that is communicating with your personal equipment for starting up and accessing service equipment 20 (FIG. 3) providing access to a service 21, 23. When starting up or when approaching service equipment 20 the system will request identification information about the user. The device 1 will then identify the user using multi biometric scanning, and provide clearing information to the equipment providing access to the service. The service in question may be physical actions such as unlocking the front door of your house, opening and starting your car, or procedures such as logging in to any service on the internet, withdrawing cash from cash machines, etc. It will be unnecessary to remember usernames, puck codes, passwords and so on as the inventive device recognizes and can authorize you.

In order to improve the personal security level, the service equipment is adapted to request the portable device 1 to provide several different biometric readings of the user, and provide the readings as a mix as the invented device can mix two or more biometric readings in order to provide a new biometric image or identity, without revealing the real identity of the original biometric images. The new image, a Cyber biometric image look alike any other biometric identifications used in the digital market for a user. The portable device 1 will then perform the selected biometric readings, combine the biometric readings, possible also with a production serial number which is unique for the portable device and possible also with other information, see below, encrypt the combination and send the result to the service equipment 20. The service equipment 20 will decode the signal from the portable device and compare the received biometric reading mix with stored information to control the identity of the user. The Cyber biometric information may be stored locally 25 in the service equipment, or retrieved from a central server 22.

As an example, two fingers may be scanned to obtain 30 coordinate points for each finger. The points for the two fingers may be combined to obtain a new identity for the user with 60 coordinate points, a “cyber finger print” in which it is impossible to know which points that belong to a particular finger. All sorts of biometric readings may be combined in this way, i.e. fingerprint readings, eye iris scans, voice readings, etc., and which may be converted to e.g. 30 coordinate values before being combined 2 by 2 or 3 by 3, etc. Then a new cyber identity is created, which is not real and is difficult to decode by anyone outside the system, if not impossible. Even if the same eye and the same finger is scanned again, the new biometrical identity will become the same, without disclosing the real individual scan values.

To further strengthen the security level, the service equipment 20 may be adapted to request at least two different biometric readings selected at random, or one biometric reading selected at random, the other biometric reading(s) being selected by the user. The system may also be adapted in such a way that all biometric readings are selected by the user or by the portable device 1 at random.

The point is that the information exchanged between the portable device and the service equipment should not be static, but change each time the user is trying to access some service. Someone eavesdropping on the communication between the portable device and service equipment cannot reuse the information to gain access to the service equipment, even if the encryption algorithm is compromised.

The device acts as a multiple information reader and do not contain or store any personal information. That is, when you use any such device nobody may take benefit or misuse a device if you should lose it in case the device is found by a dishonest person. The invention will protect you as a safe person as no one else can start up and match or use your cyber biometric images to match the images in your digital equipment, even when they are stolen.

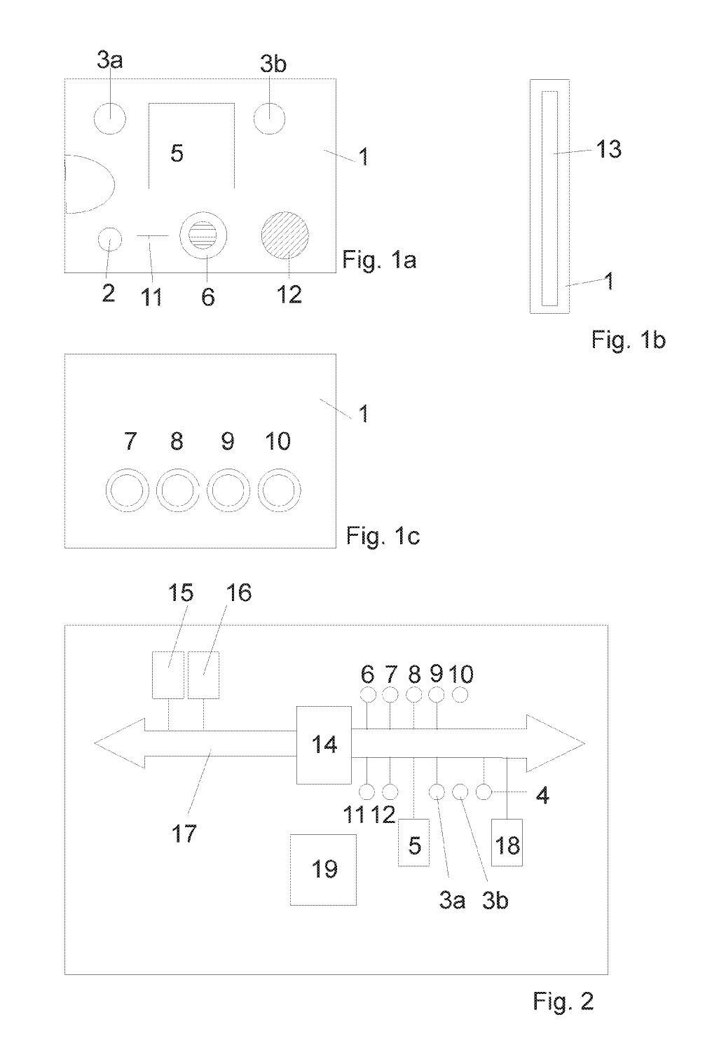

As shown in FIG. 2, the device 1 includes a microcomputer chipset 14, RAM 15, and ROM 16. The device includes a number of biometric fingerprint readers 6-10, one 6 for the thumb on the front of the device 1 and at least one up to four other fingerprint readers 7-10 on the back of the device (FIGS. 1a and 1b). Each fingerprint reader may have a double function as a switch button and include a LED source, e.g. in a ring around the reader/button that lights up when the finger is correctly positioned on the fingerprint reader or when the button is depressed.

The device may also include an eye scanner as iris/eye color circle or face shape reader (with a daylight camera 3a and/or a night camera 3b), with option to use Retinal Scan. The device may also include a microphone 11 and loudspeaker 12 providing an audio interface as described in detail in co-pending WO 2014/021721. The device may also include a distance indicator (“proximity badge”) and a small display 5, as well as a DNA reader in the future. There is also a smart card reader 4 accessible through a slot 13 at the side of the portable device 1 to read your credit, bank, passport and ID-cards. The device may also have a GPS receiver (Global Positioning System) to verify the location of a portable device before connection to prevent interaction to “pirate systems” occupying space in others computers. The device 1 runs on a rechargeable battery 19 and is turned on/off with a button 2 at the front of the device. The device 1 includes at least one wireless transceiver 18 for communicating with the outside world.

The various units 3-19 are communicating with the computer chipset 14 through buses as shown in FIG. 2.

Preferably, the device should not include any accessible storage means for permanent storage, i.e. no outside part may store instructions in the device. The device is only able to read instructions hard programmed in ROM 16 and the RAM 15 will be flushed after each session. Without data storage you cannot be robbed for biometric data or passwords if the device is lost or stolen. The device will only generate biometric mixed and encrypted data so “your private biometry” remains a secret and cannot be used, i.e. misused, by others. As the device has no recollection when stolen or lost, your private data and passwords are not compromised.

The inventive device is adapted to read at least two biometric scans identifying the user, mix the readings, encrypt the information and transmit the information to service equipment 20, FIG. 3. The service equipment 20 may be adapted to operate services such as local physical devices 21, but may also provide access to services 23 on the Internet (illustrated with the line 24 in FIG. 3), e.g. for file storage, backup services, bank services, etc. When approaching or starting servicing equipment, e.g. pressing the “power on” button on your portable (PC, Mac®, Pad, Iphone®, Android® . . . ) it will send a signals to the device 1 to identify the device as an original and un-tampered unit, by checking a QR coded cryptic unique production series number with parity check or other “unidentified” coding before requesting the biometric units to start up.

The communication between the device 1 and equipment 20 is encrypted, preferably using type NFC or Bluetooth® solutions. All signals are scrambled by a security chip such as TPCM type for sending only encrypted data. The device may also be restricted to short range communication (some centimeters or even less) to prevent other parties from receiving and decoding the information. When activating the proximity function between your equipment and the device in your pocket you can also stop others from using an ongoing session when disturbed by coworkers or family. With the proximity function activated you can prevent people using your equipment if you have to leave your powered on units behind. The proximity function uses a “proximity badge” as mentioned above.

Your bankcard, ID card or passport may be read by first inserting it into a slot 13 in the inventive device. Then your biometric readings in the card will be verified by comparing with biometric data read by the device. If both results transmitted wireless to the external equipment from the invention device matches, you are identified as the bankcard, ID card or passport owner/user. This may be a handy solution for making identification for access, admission or payments when shopping.

The invented device provides a Personal Safe, Universal, Cyber biometric Unique identification solution for one (1) user only. IT is made ready to work wireless with all existing and available biometrical identification solution as from Google, Microsoft, Apple, Samsung, Huawei etc. The invented device don't require to be initiated or used through or in accordance with any “authentication server” as it function by communicate direct as implemented and matching images in standard solutions as in mobiles, PADS, PC, most doors, internet, online payments, governmental and banking solutions.

1-11. (canceled)

12. A method for authenticating a user of a system to provide access to a service, the system including service equipment and a portable device communicating wirelessly with the service equipment, the service equipment including or having access to a storage containing cyber-biometric ID data relating to the user, the portable device including a plurality of biometric readers, the method comprising:
requesting, by use of the service equipment, the portable device to perform at least two different selected biometric readings on the user, wherein (i) all of the biometric readings are selected at random by the service equipment, (ii) at least one of the at least two biometric readings is selected by the user or the portable device and the other biometric reading(s) is selected at random by the service equipment, or (iii) all of the biometric readings are selected at random by the user or the portable device;
performing the biometric readings on the user by use of the biometric readers of the portable device;
combining the biometric readings and a production serial number of the portable device to form a mixed cyber-biometric identity of the user that is an anonymous ID unique to only the user;
transmitting the mixed cyber-biometric identity to the service equipment for comparing the received mixed cyber-biometric identity with the stored cyber-biometric ID data; and
if the received mixed cyber-biometric identity and stored cyber-biometric ID data agree, allowing the user access to the service.

13. The method according to claim 12, wherein the portable device is encrypting the mixed cyber-biometric identity transmitted to the service equipment.

14. A system for personal-safe authenticating a user of a service, the system comprising service equipment and a portable device communicating wirelessly with the service equipment, the service equipment including or having access to a storage containing cyber-biometric data relating to the user, the portable device including a plurality of biometric readers, and
wherein the service equipment is adapted to request the portable device to perform at least two different selected biometric readings on the user, wherein (i) all of the biometric readings are selected at random by the service equipment, (ii) at least one of the biometric readings is selected by the user or the portable device and the other biometric reading(s) is selected at random by the service equipment, or (iii) all biometric readings are selected at random by the user or by the portable device;
wherein the portable device is adapted to perform the selected biometric readings on the user and combine the biometric readings, wherein a secret alpha-numeric production serial number is stored in the portable device, the portable device being further adapted to combine part or all of the production serial number with the selected biometric readings to form a mixed cyber-biometric identity for the user and transmit the mixed cyber-biometric identity to the service equipment; and
wherein the service equipment is adapted to compare the received mixed cyber-biometric identity with the stored cyber-biometric data and, if the received mixed cyber-biometric data and stored cyber-biometric data agree, to allow the user access to the service.

15. The system of claim 14, wherein the portable device is adapted to encrypt the mixed cyber-biometric identity transmitted to the service equipment.

16. The system of claim 14, wherein the portable device includes a CPU chipset, ROM, workspace RAM, a multitude of biometric readers, a wireless communication transceiver, and a power supply, the portable device being operated only by data permanently stored in the ROM, the workspace RAM being flushed after each operating cycle.

17. The system of claim 15, wherein the portable device includes a CPU chipset, ROM, workspace RAM, a multitude of biometric readers, a wireless communication transceiver, and a power supply, the portable device being operated only by data permanently stored in the ROM, the workspace RAM being flushed after each operating cycle.

18. The system of claim 14, wherein the mixed cyber-biometric identity is derived from only a part of the alpha-numeric data of the serial number of the portable device.

19. A portable device to be used in the system of claim 14, wherein the portable device includes a CPU chipset, ROM, workspace RAM, a multitude of biometric readers, wireless communication means and power supply means, the device being operated only by data permanently stored in the ROM, the workspace RAM being flushed after each operating cycle, wherein the portable device is adapted to perform at least two selected biometric readings of a user, combine the biometric readings and transmit the result of the combination to the service equipment.

20. A service equipment for use in a system providing access to a service, the service equipment including a communication device for communicating with a portable device, the service device having access to storage that stores cyber-biometric ID-data corresponding to biometric readings from the user and a plurality of stored cyber-biometric identities for the user, each of the plurality of stored cyber-biometric identities are formed from at least two cyber-biometric ID data sets from the user combined with a part or all of a serial number for the portable device, the stored cyber-biometric identities forming a unique identity for the user, and wherein, in response to the user seeking access to the service, the service equipment selects the biometric readings to be provided by the user from the portable device, the service equipment receives a mixed cyber-biometric identity derived from the selected biometric readings from the portable device and part or all of the serial number for the portable device, the service equipment comparing the mixed cyber-biometric identity with similar stored cyber-biometric identities from the storage and providing the user with access to the service if the mixed cyber-biometric identity and the stored cyber-biometric identity agree.

21. The service equipment of claim 20, wherein at least one of the selected biometric readings are selected at random by the service equipment.

22. The service equipment of claim 20, wherein the portable device is adapted to encrypt the mixed cyber-biometric identity transmitted to the service equipment.

23. The service equipment of claim 20, wherein the mixed cyber-biometric identity is derived from only a part of the alpha-numeric data of the serial number of the portable device.
